(19) United States
(12) Patent Application Publication
(10) Pub. No.: US 2005/0253829 A1
(43) Pub. Date: Nov. 17, 2005

(54) Display device and display device driving method

(76) Inventors: Norio Mamba, Kawasaki (JP); Yasuyuki Kudo, Fujisawa (JP); Takashi Shoji, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/103,492

(22) Filed: Apr. 12, 2005

(30) Foreign Application Priority Data
Apr. 13, 2004 (JP) 2004-117518

(51) Int. Cl. G09G 5/00

(52) U.S. Cl. 345/204

(57) ABSTRACT

A display device of the present invention includes a plural scan lines, plural signal lines each intersecting each of the plural scan lines, plural counter-electrode lines each extending along each of the plural scan lines, plural pixels each connected to each of the plural scan lines, to each of the plural signal lines, and to each of the counter-electrode lines, a scan driver which applies a scanning signal to each of the plural scan lines, a signal driver which applies a signal voltage to each of the plural signal lines, a counter-electrode driver which applies a counter-electrode voltage to each of the counter-electrode lines, and a generator which supplies a counter-electrode signal to the third driver. When the scanning signal is applied to one of the scan lines, the counter-electrode driver applies the counter-electrode signal to the counter-electrode line associated with the scan line.

### CLAIM OF PRIORITY

The present application claims priority from Japanese application serial No. 2004-117518 filed on Apr. 13, 2004, the content of which is hereby incorporated by reference into this application.

### BACKGROUND OF THE INVENTION

The present invention relates to an active matrix type display device that inverts the polarities of the signal potentials applied to the counter electrodes of the display device. The invention also relates to a method of driving the display device.

Liquid-crystal display devices have a liquid crystal sandwiched between a substrate having a pixel array formed thereon, and another substrate opposed to the substrate. Such a display device modulates the light transmittance of the liquid crystal by applying signal voltages responsive to display signals, between pixel electrodes provided on the same substrate as that of the pixel array, and counter electrodes, and thus makes multi-grayscale-level displays.

When the counter electrodes are provided on the same substrate as that of the pixel array, the liquid crystal is called the “in-plane switching liquid crystal”, which is controlled by a lateral electric field. Conversely, when the counter electrodes are provided on the substrate opposed to that having the pixel array formed thereon, the liquid crystal is called the “twisted nematic liquid crystal” or the like, and is controlled by a vertical electric field. Although different in the direction of the electric field applied to the liquid crystal, these liquid-crystal control schemes are of the same driving method.

In liquid-crystal display devices, a display deterioration called “burn-in” will occur if a signal voltage of the high-potential side (positive polarity) or a signal voltage of the low-potential side (negative polarity), with respect to the potential of a counter electrode, is continuously applied to a pixel electrode. The voltage signal applied, therefore, needs to be inverted from positive polarity to negative polarity, or vice versa, with a certain period.

In general, driving schemes for the liquid-crystal display devices outlined above can be classified into two types. One type is a method in which the potential of the counter electrode is fixed, and the other type is a method in which the potential of the counter electrode is inverted (hereinafter, this driving method is referred to as counter-electrode inversion driving). In the former driving method, since the potential of the counter electrode is constant, this requires the use of a signal-driving circuit by which the signal potential applied to the pixel electrode is to be changed over the output range from positive-polarity voltages to negative-polarity voltages.

In contrast to the above, the latter driving scheme (namely, counter-electrode inversion driving) periodically inverts the polarities of two types of counter-electrode voltages. One type is a low-potential counter-electrode voltage that is needed to apply a signal voltage of positive polarity to the pixel electrode (hereinafter, this voltage is referred to as the counter-electrode voltage of positive polarity). The other type is a high-potential counter-electrode voltage that is needed to apply a signal voltage of negative polarity to the pixel electrode (hereinafter, this voltage is referred to as the counter-electrode voltage of negative polarity).

Accordingly, the voltage output range of the signal-driving circuit diminishes to nearly half that of the signal-driving circuit in the former scheme, and the withstand voltage of the signal-driving circuit can be lowered. As a result, component costs can be reduced for LSI construction of the signal-driving circuit. Also, since the voltages that the signal-driving circuit outputs are small in amplitude, counter-electrode inversion driving is suitable for high-speed operation.

In recent years, however, reduction in one horizontal scanning period of each liquid-crystal display device, coupled with the enhancement of its resolution (increases in the number of scan lines), and increases in wiring loads, coupled with the extension of liquid-crystal display areas, have caused waveform edge rounding during polarity inversion of the counter-electrode voltage. Also, such waveform rounding has resulted in image quality deterioration such as the nonuniformity of display, since a desired potential is not attained within one horizontal scanning period. JP-A-2001-356356 describes a liquid-crystal display device that solves the problem of waveform rounding during polarity inversion of the counter-electrode voltage. In this liquid-crystal display device, the counter electrodes of the pixels lying on one horizontal line are shared to form counter electrode lines in a horizontal direction, and connections between the odd-numbered lines of these counter electrode lines and between even-numbered lines, are conducted in common at respective ends. A first counter electrode and a second counter electrode are thus formed. Also, first and second counter-electrode voltages whose polarity inversion alternates between both are applied to the first and second counter electrodes, respectively. Thus, counter-electrode inversion driving is conducted in which the polarities of the signal voltages to be applied to pixel electrodes change in increments of one horizontal period. In addition, the polarities of the first and second counter electrodes are inverted during the blanking period of a pixel electrode signal. This prevents polarity inversion of the counter-electrode voltages in increments of one horizontal period and waveform rounding due to such inversion, so that the liquid-crystal display device is described as a high-quality display device free from image quality deterioration such as the nonuniformity of display.

Also, JP-A-2003-255907 describes a display device that independently drives individual common electrode lines (counter-electrode lines).

### SUMMARY OF THE INVENTION

The liquid-crystal display device described in JP-A-2001-356356 changes in pixel electrode potential since, after the pixels on each horizontal line have been caused to hold (write) a signal voltage, the polarity of the Counter-electrode voltage is inverted during the blanking period. At this time, the polarity inversion period of the after-writing counter-electrode voltage differs between the pixel that has held the voltage in the first half of a frame, and the pixel that has held the voltage in the second half of the frame. Accordingly, the nonuniformity of display, called “graded luminance” or “vertical smear”, is liable to occur and thus result in image quality being deteriorated.

Also, since the inversion of the counter-electrode voltage in the blanking period changes the pixel electrode potentials of all pixels at the same time, this could cause flickering if the frame frequency is too low.

In addition, in the display device described in JP-A-2003-255907, the circuit scale increases since a common electrode-driving circuit is required.

An object of the present invention is to provide: a high-quality display device that suppresses image quality deterioration such as nonuniform display and flickering, while at the same time suppressing an increase in circuit scale; and a driving method for the display device.

An aspect of the present invention is a display device including a plurality of scan lines, a plurality of signal lines each intersecting with each of the plural scan lines, a plurality of counter-electrode lines each parallel to each of the scan lines, a plurality of pixels each disposed at each intersecting position between any one of the scan lines and any one of the signal lines, a scan-driving circuit for applying a scanning signal to each of the scan lines, and a signal-driving circuit for applying to each of the signal lines a signal voltage associated with a pixel connected to the scan line to which a selection voltage has been applied via the scanning signal; wherein the display device further has a counter-electrode signal generating circuit that generates counter-electrode signals as inversion signals for a counter-electrode voltage of positive polarity and a counter-electrode voltage of negative polarity, and a counter-electrode driving circuit that applies the counter-electrode voltages to the counter-electrode lines, the counter-electrode driving circuit being controlled by the scanning signal that the scan-driving circuit outputs.

Another aspect of the present invention is a display device including a plurality of scan lines, a plurality of signal lines each intersecting with each of the plural scan lines, a plurality of counter-electrode lines each parallel to each of the scan lines, a plurality of pixels each disposed at an intersecting position between any one of the scan lines and any one of the signal lines, a scan-driving circuit for applying a scanning signal to each of the scan lines, and a signal-driving circuit for applying to each of the signal lines a signal voltage associated with a pixel connected to the scan line to which a selection voltage has been applied via the scanning signal; wherein the scan-driving circuit is of a selector scheme in which it includes a plurality of selector blocks and is controlled by a block select signal and a clock signal; and wherein the display device further has a counter-electrode signal generating circuit that generates, for each group of horizontal lines scanned using the select block of the scan-driving circuit, counter-electrode signals as inversion signals for a counter-electrode voltage of positive polarity and a counter-electrode voltage of negative polarity, and a counter-electrode driving circuit that applies the counter-electrode voltages that have been generated for each group of the horizontal lines, to the counter-electrode lines of the horizontal line group, the counter-electrode driving circuit being controlled by the clock signal of the scan-driving circuit.

According to the present invention, particularly the advantageous effects listed as items (1) to (7) can be obtained.

(1) The polarities of the counter-electrode voltages are not inverted during the time interval from completion of signal voltage held by the pixels of each horizontal line, to the start of each horizontal line writing operation in the next frame period. This makes it possible to obtain a high-quality display device in which the nonuniformity of display, called “graded luminance” or “vertical smear”, is suppressed.

(2) A high-quality display device that does not easily cause flickering, even at low frame frequencies, can be obtained since polarity inversion of the counter-electrode voltages occurs in distributed form for each line within the frame period.

(3) Polarity inversion of the counter-electrode voltages is not conducted from completion of signal voltage held by the pixels of each horizontal line, to the start of each horizontal line writing operation in the next frame period. Thus, it becomes possible to reduce the voltage amplitude of the scanning signal, compared with that achievable in conventional technology, and hence to lower the withstand voltages of elements. Also, the deterioration of the elements can be lessened by reducing the voltage amplitude of the scanning signal, and thus a high quality display device can be obtained.

(4) on each horizontal line, the counter-electrode lines are maintained in a high-impedance condition during a non-selection period. Therefore, the loads on each signal line having a parasitic capacitance between counter-electrode lines are seemingly reduced and a convergence time up to the arrival of the signal voltage applied to the signal line, at a target potential, is improved as a result. A display device suitable for high-speed operation can thus be obtained.

(5) Counter-electrode inversion driving can be applied to a display device high in image quality and low in electric power consumption.

(6) Counter-electrode line driving based on the scanning signal makes other control signals and terminals unnecessary, hence allowing an increase in circuit scale to be suppressed.

(7) The counter-electrode lines take a floating state, which improves the convergence of the signal lines and makes image quality improvable.

### BRIEF DESCRIPTION OF THE DRAWINGS

FIG. 1 is a schematic diagram of a liquid-crystal display device in a first embodiment;

FIG. 2 is a timing chart of the signals that a driving circuit outputs in the first embodiment;

FIG. 3 is a voltage waveform diagram of the electrodes of pixels in the first embodiment;

FIG. 4 is a schematic diagram of a liquid-crystal display device in a second embodiment;

FIG. 5 is a timing chart of the signals that a driving circuit outputs in the second embodiment;

FIG. 6 is a voltage waveform diagram of the electrodes of pixels in the second embodiment;

FIG. 7 is a schematic diagram of a liquid-crystal display device in a third embodiment;

FIG. 8 is a timing chart of the signals that a driving circuit outputs in the third embodiment; and

FIG. 9 is a voltage waveform diagram of the electrodes of pixels in the third embodiment.

### DETAILED DESCRIPTION OF THE PREFERRED EMBODIMENTS

Embodiments of the present invention will be described hereunder using the accompanying drawings.

Examples of liquid-crystal display devices each using a liquid-crystal material in its pixel section are shown in the following description of embodiments. Basic structures and driving methods of these display devices, however, are also applicable to the display devices that employ an electroluminescent material or light-emitting diode elements.

### First Embodiment

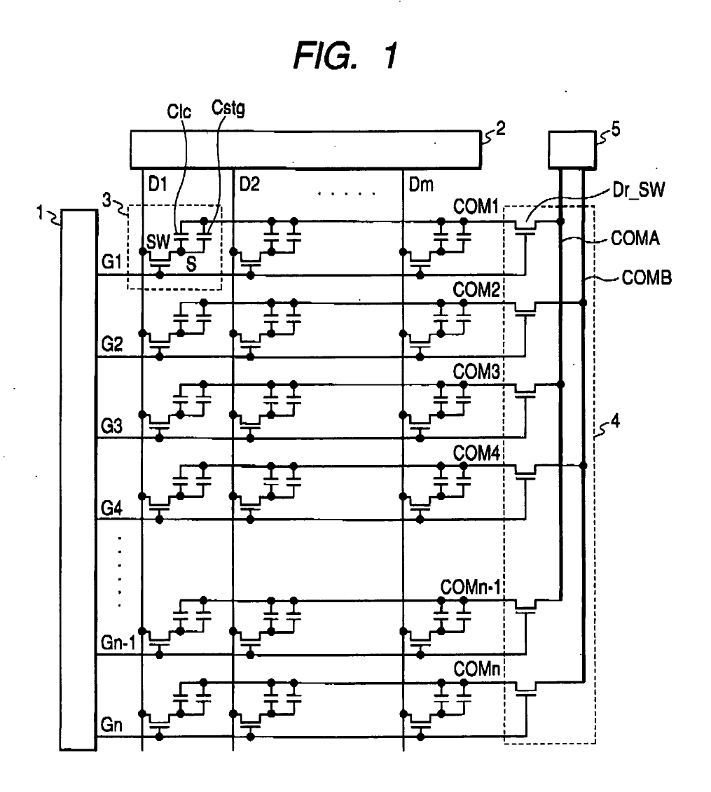

First, a first embodiment of a display device and its driving method according to the present invention is described with reference to FIGS. 1 to 3.

FIG. 1 is a schematic diagram showing a configuration of the liquid-crystal display device operating in the first embodiment of the present invention. The configuration of the liquid-crystal display device in the first embodiment is described below. The liquid-crystal display device shown in the figure is described assuming that the number of dots in a horizontal direction is “m” and that the number of lines in a vertical direction is “n”. In the liquid-crystal display device, an “n” number of scan lines are arranged as G1, G2, G3, G4, . . . Gn−1, Gn. A scanning signal output from a scan-driving circuit 1 (hereinafter, referred to simply as the scan driver 1) is applied to each of the scan lines G. Also, an “m” number of signal lines are arranged as D1, D2, . . . Dm, in the direction where the signal lines intersect the scan lines G. Each of the signal lines D is impressed with a signal voltage responsive to a display signal output from a signal-driving circuit 2 (hereinafter, referred to simply as the signal driver 2).

An “n” number of counter-electrode lines are arranged an COM1, COM2, COM3, COM4, . . . COMn−1, COMn, in the same direction as that of the scan lines G. A counter-electrode signal output from a counter-electrode driving circuit 4 (hereinafter, referred to simply as the counter-electrode driver 4) is applied to each of the counter-electrode lines COM.

A pixel 3 including a switching element is disposed in the vicinity of positions at which each scan line G and each signal line D intersect each other. In the liquid-crystal display device, therefore, an “m” number of pixels 3 and an “n” number of pixels 3 are arranged in a matrix format in horizontal and vertical directions, respectively. Each pixel 3 is constituted of a switching element SW, a liquid crystal capacitor “Clc”, a hold capacitor “Cstg” (when necessary), and a pixel electrode S and counter electrode for forming each such capacitor.

A three-terminal element such as a thin-film transistor (TFT) is used as the switching element SW, and the TFT is formed of amorphous silicon (Si), polysilicon, single-crystal Si, or the like. The switching element SW has its gate terminal connected to a scan line G, and on/off control of the switching element is based on a scanning signal applied to the particular scan line G.

In the liquid-crystal display device of the first embodiment, gate terminals of switching elements SW of the pixels 3 arranged on one horizontal line are connected to one scan line G associated with that horizontal line. Also, a drain terminal of each switching element SW is connected to a signal line D. When the switching element SW is controlled to an “on” state by the scanning signal applied to the scan line, a signal voltage applied to the signal line is propagated to the pixel electrode S connected to a source terminal of the switching element SW. In addition, drain terminals of switching elements SW of the pixels 3 arranged on one vertical line are connected to one signal line D. The counter electrodes included in the pixels 3 arranged on one horizontal line are connected to one counter-electrode line COM associated with that horizontal line.

A counter-electrode signal generating circuit 5 (hereinafter, referred to simply as the counter-electrode signal generator 5) generates inversion signals for a counter-electrode voltage “Vcom#hi” of positive polarity and a counter-electrode voltage “Vcom#low” of negative polarity. Both counter-electrode voltages are required for counter-electrode inversion driving. The counter-electrode signal generator 5 outputs the inversion signals to a first counter-electrode signal line COMA and a second counter-electrode signal line COMB.

The counter-electrode driver 4 includes an “n” number of switching elements shown as “Dr#SW”. A three-terminal element such as a TFT is used as each switching element “Dr#SW”, and the TFT is formed of amorphous Si, polysilicon, or single-crystal Si.

A source terminal of the switching element “Dr#SW”, is connected to each counter-electrode signal line COM. A drain terminal is connected to the first counter-electrode signal line COMA and the second counter-electrode signal line COMB, for each alternate horizontal line, for example.

For the liquid-crystal display device of FIG. 1, odd-numbered lines are connected to the first counter-electrode signal line COMA and even-numbered lines are connected to the second counter-electrode signal line COMB. Also, a gate terminal of the switching element “Dr#SW” is connected to the scan line that controls the pixels sharing the counter-electrode lines connected to the source terminal of the particular switching element “Dr#SW”.

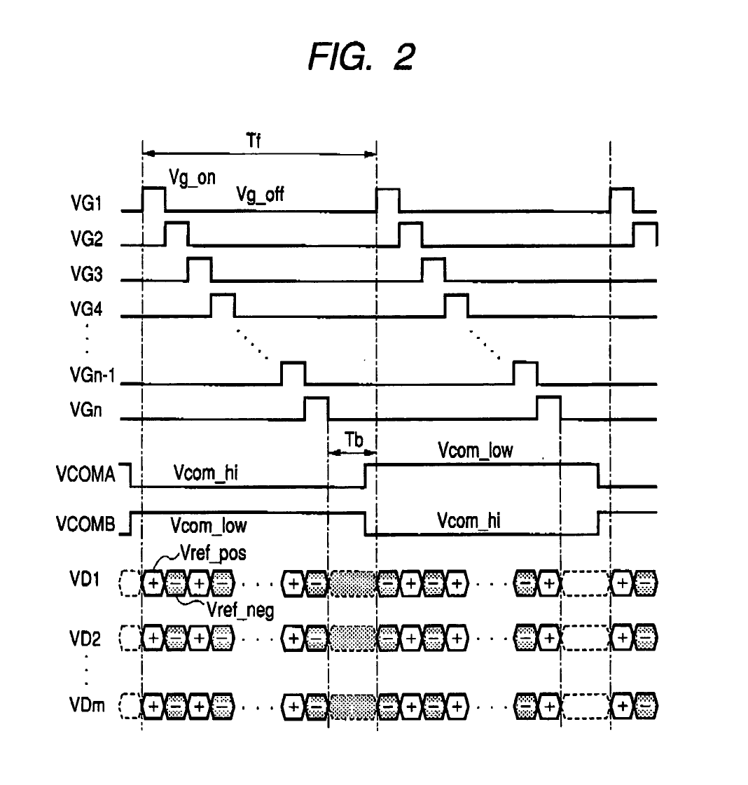

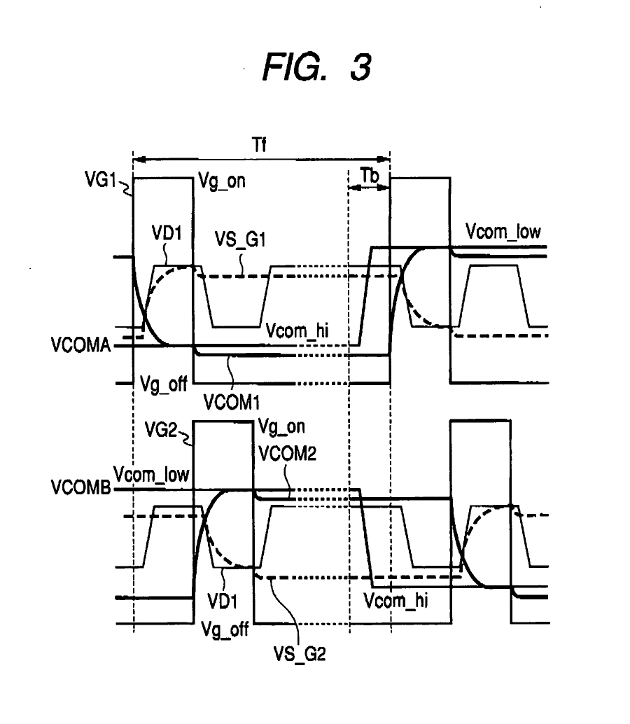

Next, a driving method for the liquid-crystal display device of the first embodiment is described below with reference to FIGS. 2 and 3. The following description assumes that the TFTs used as the switching element SW and “Dr#SW” are, for example, n-type TFTS. The following description also assumes counter-electrode inversion driving by which polarity of the signal voltage output by the signal driver 2 is inverted in increments of, for instance, one horizontal period.

FIG. 2 is a chart that shows timing of the signals output by the scan driver 1, the signal driver 2, and the counter-electrode signal generator 5. Symbols VG1, VG2, VG3, VG4, . . . VGn−1, VGn, denote the scanning signals applied to the scan lines G1, G2, G3, G4, . . . Gn−1, Gn, respectively. Symbol “Vg#on” denotes a selection signal level for turning on the switching element SW, and symbol “Vg#off” denotes a non-selection signal level for turning off the switching element SW. Since it is assumed that the switching element SW included in each pixel 3 is an n-type TFT, a voltage signal of a high level (“Hi”) is of the selection signal level, whereas a voltage signal of a low level (“Low”) is of the non-selection signal level.

A condition in which “Vg#on” is sequentially applied to horizontal lines from a first horizontal line to an nth one is shown in FIG. 2. The scan driver 1 applies “Vg#on” to each horizontal scan line at least once during one frame period Tf. The scan driver 1 repeats this operation sequence for each frame. Symbols VCOMA and VCOMB denote the counter-electrode signals that the counter-electrode signal generator 5 generates and then outputs to the first counter-electrode signal line COMA and the second counter-electrode signal line COMB, respectively.

VCOMA and VCOMB are the inversion signals for “Vcom#hi” and “Vcom#low”, the polarities of both are inverted within one-frame blanking period Tb (usually, a period during which no signal is rewritten into the display device because of a display signal being absent). Alternating-current frequencies of VCOMA and VCOMB, therefore, become ½ of a frame frequency. At least during a period of signal voltage writing into pixels, VCOMA and VCOMB also output counter-electrode voltages of opposite polarities.

Symbols VD1, VD2, . . . VDm signify the signal voltages that the signal driver 2 applies to the signal lines D1, D2, . . . DM. Also, “Vref#pos” denotes a signal voltage of positive polarity, and “Vref#neg” denotes a signal voltage of negative polarity.

The signal driver 2 outputs a signal voltage appropriate for display signals associated with each pixel selected by the selection signal “Vg#on”, to signal lines D associated with each pixel. The polarity of the signal voltage at that time depends on the polarity of the counter-electrode signal applied to the counter electrode of the pixel, and when “Vcom#hi” is applied, “Vref#pos” is output as a signal voltage of positive polarity, or when “Vcom#low” is applied, “Vref#neg” is output as a signal voltage of negative polarity.

During the frame period shown in the first half of FIG. 2, odd-numbered counter-electrode lines are connected to COMA via internal “Dr#SW” elements of the counter-electrode driver 4. Since the signal of COMA is “Vcom#hi”, the signal voltage of positive polarity, “Vref#pos”, is output during a selection period for the pixels of the odd-numbered lines.

Even-numbered counter-electrode lines are connected to COMB via “Dr#SW”, and since the signal of COMB is “Vcom#low”, the signal voltage of negative polarity, “Vref#neg”, is output during a selection period for the pixels of the even-numbered lines.

During the frame period that follows, signal polarities of VCOMA and VCOMB are inverted, so that the signal voltages output to the pixels of each horizontal line are also inverted in terms of polarity.

FIG. 3 is a diagram that shows the voltage waveforms developed at pixels when the signals shown in FIG. 2 are applied to the pixels. Of all pixels connected to the signal line D1, for example, only the pixels connected to the scan lines G1 and G2 have the respective voltage waveforms shown in FIG. 3.

In FIG. 3, symbol VS#G1 denotes a voltage signal developed at the pixel electrode S of the pixel connected to the scan line G1, and VS#G2 denotes a voltage signal developed at the pixel electrode S of the pixel connected to the scan line G2. Also, VCOM1 denotes a voltage signal of the counter-electrode line on a first horizontal line, and VCOM2 denotes a voltage signal of the counter-electrode line on a second horizontal line.

First, in one frame period, when the pixel of the first horizontal line is selected by the scanning signal VG1, VCOMA is applied to the counter-electrode COM1 via the appropriate internal “Dr#SW” of the counter-electrode driver 4. The voltage VCOM1 of the counter electrode COM1, therefore, converges on “Vcom#hi”.

Meanwhile, a positive-polarity signal voltage VD1 appropriate for the display signal of the pixel propagated via the signal line D1 is applied to the pixel electrode S via the switching element SW, and VS#G1 converges on signal voltage VD1.

After the selection period for the first horizontal line, since the switching element SW and “Dr#SW” are both turned off, although the pixel electrode S and the counter electrode COM1 enter a floating state, the signal voltage of positive polarity that was applied during the selection period is held by the liquid crystal capacitor “Clc” and the hold capacitor “Cstg”. During a hold period of the signal voltage, since COM1 is in a floating state, the signal polarity of the counter electrode COM1 is not inverted, even when the polarity of VCOMA is inverted. That is, even when the polarity of VCOMA is inverted, the held signal voltage is not affected.

Next, when the pixel of the second horizontal line is selected by the scanning signal VG2, VCOMB is applied to the counter-electrode COM2 via the appropriate internal “Dr#SW” of the counter-electrode driver 4. The voltage VCOM2 of COM2, therefore, converges on “Vcom#low”.

Meanwhile, a negative-polarity signal voltage VD1 appropriate for the display signal of the pixel propagated via the signal line D1 is applied to the pixel electrode S via the switching element SW, and VS#G2 converges on signal voltage VD1.

After the selection period for the second horizontal line, since the switching element SW and “Dr#SW” are both turned off, although the pixel electrode S and the counter electrode COM2 enter a floating state, the Signal voltage of negative polarity that was applied during the selection period is held by the liquid crystal capacitor “Clc” and the hold capacitor “Cstg”. During a hold period of the signal voltage, since COM2 is in a floating state, the signal polarity of the counter electrode COM2 is not inverted, even when the polarity of VCOMB is inverted. That is, even when the polarity of VCOMB is inverted, the held signal voltage is not affected.

The signal voltage that is associated with a one-frame display signal and has been polarity-inverted for each horizontal line can be held in the pixels of all horizontal lines by sequential repetition of the operation described above.

During the one-frame period shown in the second half of FIG. 2, the polarity of the counter-electrode voltage is inverted on each horizontal line, the signal voltage output from the signal driver 2 to each pixel also assumes opposite polarity, and similar driving is conducted. Thus, a signal voltage associated with a one-frame display signal can be held in the pixels of all horizontal lines. Repeating the above driving for each frame makes it possible to implement counter-electrode inversion driving that inverts the polarities of signal voltages for each horizontal line.

Use of the liquid-crystal display device and its driving method in the first embodiment of the present invention provides the invention with the features and characteristics listed in items (1) to (6) below.

(1) The polarities of the counter-electrode voltages are not inverted during a time interval from completion of signal voltage hold by the pixels of each horizontal line, to a start of each horizontal line rewriting operation in the following frame period. Thus, it becomes possible to implement high-quality display during which nonuniform display, called “graded luminance” or “vertical smear”, is suppressed.

(2) A high-quality display device that does not easily cause flickering, even at low frame frequencies, can be obtained since polarity inversion of the counter-electrode voltages applied to the counter electrodes of each horizontal line occurs in distributed form for each line within the frame period.

(3) The polarities of the counter-electrode voltages are not inverted during the time interval from completion of signal voltage held by the pixels of each horizontal line, to the start of each horizontal line rewriting operation in the following frame period. Thus, it becomes possible to reduce voltage amplitude of the scanning signal, compared with that achievable in the conventional technology, and hence to reduce elements in withstand voltage. Also, deterioration of the elements can be lessened by reducing the voltage amplitude of the scanning signal, and thus a high-quality display device can be obtained.

(4) on each horizontal line, the counter-electrode lines are in a floating state during a non-selection period. Therefore, the loads applied to each signal line having a parasitic capacitance between counter-electrode lines are reduced and a convergence time up to an arrival of the signal voltage applied to the signal line, at a target potential, is improved as a result. A display device suitable for high-speed operation can thus be obtained.

(5) Because of its small circuit scale, the counter-electrode driver 4 can be formed on the same substrate as that on which the switching element SW of each pixel 3 is formed.

(6) Since the counter-electrode driver 4 can be controlled using the scanning signal of the scan driver 1, there is no need to provide an independent control signal for the counter-electrode driver 4.

In the configuration diagram of FIG. 1, two counter-electrode signal lines are shown as signal output lines of the counter-electrode signal generator 5. As with above-described inversion driving, however, counter-electrode inversion driving that inverts the polarities of signal voltages for each horizontal period can be realized. That is, this is possible by using one counter-electrode signal line, instead of two lines, connecting all drain terminals of the “Dr#SW” within the counter-electrode driver 4 to that counter-electrode signal line, and inverting, for each horizontal period, the polarity of the signal applied to the counter-electrode signal line.

Also, although in the above description, the polarity inversion period of signal voltages during counter-electrode inversion driving is set to be equal to one horizontal period, this polarity inversion period may be arbitrarily set. This can be realized by setting the polarities and alternating-current periods of VCOMA and VCOMB as appropriate.

Additionally, for improved convergence of the pixel electrode voltage and the counter-electrode voltage on respective target voltage values, circuit operation can be combined with double-gate driving in which, before a signal voltage associated with the particular display signal is written, signal voltages of the same polarity are temporarily written.

Furthermore, in the configuration diagram of FIG. 1, use of amorphous Si or polysilicon makes it possible to form the pixel matrix and the counter-electrode driver or the pixel matrix, the counter-electrode driver, and the scan driver, on one substrate and arrange other circuits on peripheral sections of the substrate.

### Second Embodiment

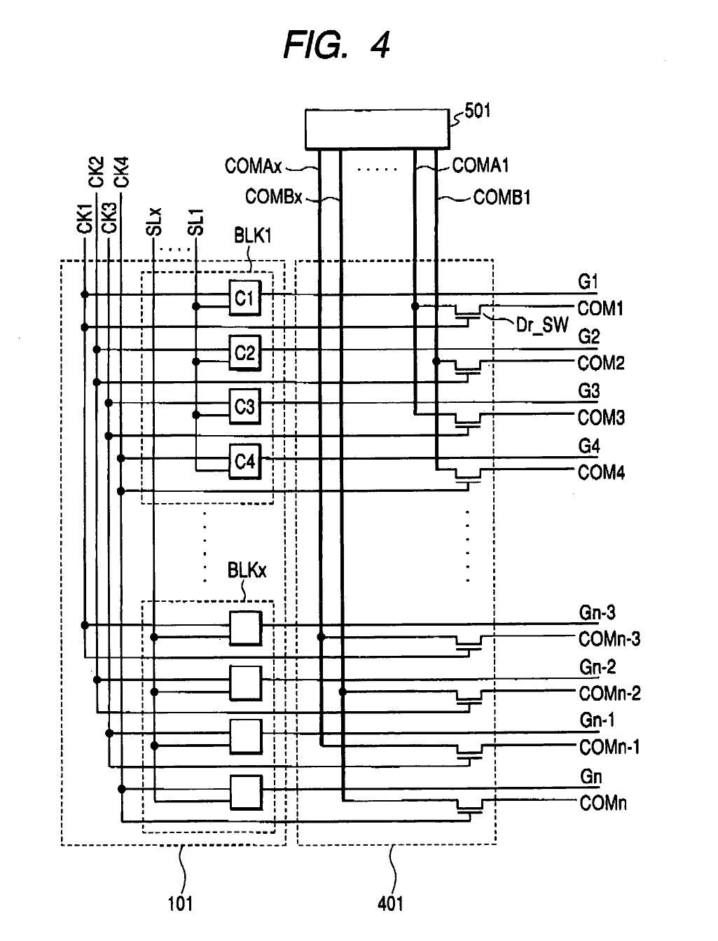

Next, a second embodiment of a display device and its driving method according to the present invention is described with reference to FIGS. 4 to 6. FIG. 4 is a schematic diagram showing a configuration of the liquid-crystal display device according to the second embodiment of the present invention.

The configuration of the liquid-crystal display device in the second embodiment is described below with reference to FIG. 4. A signal driver 2, a pixel matrix formed up of pixels 3, signal lines D for supplying signals, scan lines G, and counter-electrode lines COM are omitted from FIG. 4 since these elements are the same as those shown in FIG. 4 of the first embodiment.

In the second embodiment of the present invention, a scan driver 101 is constructed on a selector scheme, wherein the scan driver 101 uses control signals to control a counter-electrode driver 401. The scan driver 101 includes a plurality of selector blocks BLK, each of which drives a plurality of scan lines. The configuration diagram of FIG. 4 applies when one selector block drives four scan lines, for instance.

As shown in FIG. 4, when the total number of horizontal lines, “n”, is 4x, an “x” number of blocks from BLK1 to BLKx are constructed. This construction applies when the number of horizontal lines, “n”, is divisible by the number of lines (4) that is a construction unit of each selector block BLK. If “n” is not divisible by 4, an extra horizontal scan line is allocated to the last selector block.

Each selector block BLK is constructed of the number of cells that is equal to that of scan lines to be driven by the selector block. That is to say, the selector block includes four cells C1, C2, C3, C4. These scan lines are connected to the respective scan lines that the selector block BLK is to drive. Also, clock signals CK1, CK2, CK3, CK4 are input to the cells C1, C2, C3, and C4, respectively. The number of clock signals CK, therefore, needs to be the same as the number of cells in the selector block.

In addition, a block select signal SL for selecting the selector block BLK that includes each cell is input to the cell. When an “x” number of selector blocks BLK are present, an “x” number of block select signal lines from SL1 to SLx are required.

The counter-electrode driver 401 includes switching elements “Dr#SW” as many as there actually are counter-electrode lines. As in the first embodiment, each of these switching elements is a three-terminal element such as a TFT, formed of amorphous Si, polysilicon, or single-crystal Si.

Each switching element “Dr#SW” has a source terminal connected to one of plural counter-electrode lines COM1, COM2, . . . COMn. Also, the same clock signal CK as that of the cell C driving the horizontal scan line including the counter-electrode line connected to the switching element is applied to a gate terminal thereof. In addition, counter-electrode signal lines COMA and COMB are provided for each selector block BLK. The horizontal line group that the first selector block BLK1 drives, therefore, is provided with COMA1 and COMB1, and the horizontal line group that the last selector block BLK1 drives is provided with COMAx and COMBx.

In the counter-electrode driver 401, in order to conduct counter-electrode inversion driving that inverts polarities of signal voltages for each horizontal period, for example, COMA is connected to a drain terminal of each switching element “Dr#SW” to which are connected the counter-electrode lines only of odd-numbered lines among all horizontal lines driven by each selector block. Also, COMB is connected to a drain terminal of each switching element “Dr#SW” to which are connected the counter-electrode lines of even-numbered lines.

The signals applied to counter-electrode signal lines COMA1, COMB1, . . . COMAx, COMBx are alternating-current signals that each alternate between a counter-electrode signal “Vcom#hi” of positive polarity and a counter-electrode signal “Vcom#low” of negative polarity. These signals are generated by and then output from a counter-electrode signal generator 501.

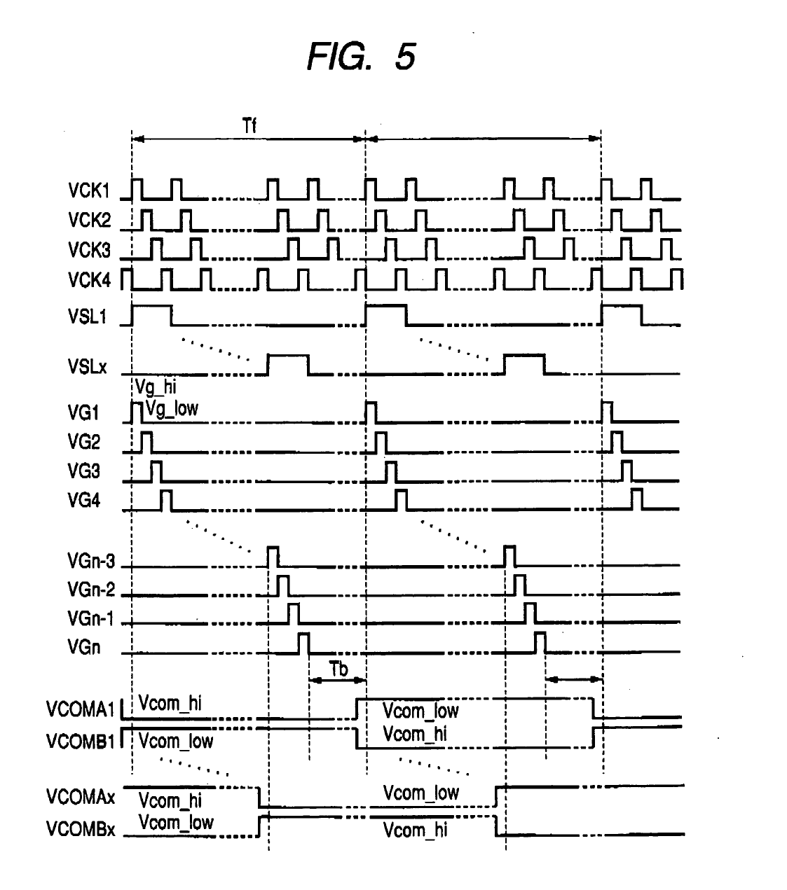

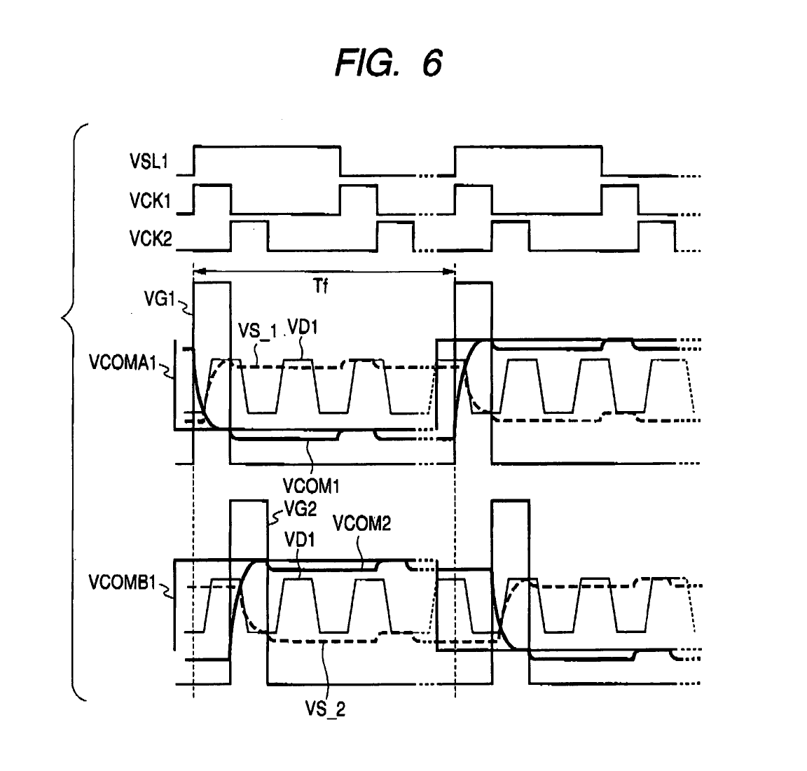

Next, operation of the liquid-crystal display device in the second embodiment, and a driving method for the display device are described below using FIGS. 5 and 6.

FIG. 5 is a chart that shows timing of a block 6 select signal VSL and clock signal VCK for controlling the scan driver 101, timing of a scanning signal VG, and timing of the counter-electrode signals VCOMA and VCOMB that are output from the counter-electrode signal generator 501

When the number of horizontal lines allocated to one selector block BLK is four, a signal of a selection level (“Hi” level) is produced from each of clock signals VCK1, VCK2, VCK3, VCK4, at a rate of at least once every four horizontal periods. Shifting a phase of each clock signal VCK by about one horizontal period makes it possible to sequentially apply, during four horizontal periods, selection levels of the clock signals to the four cells, from C1 to C4, that constitute the selector block.

Four horizontal periods of signal data of the “Hi” selection level is produced from block select signal VSL at the rate of at least once during one frame period. During a selection period of the block select signal VSL, therefore, a signal of a selection level is produced from each of the above-mentioned clock signals VCK at least once. Since each block select signal is output with its phase shifted by, for example, about four horizontal periods, it is possible to sequentially apply a selection signal to each selector block and thus to apply a signal of a selection level to all selector blocks at least once during one frame period.

When both the block select signal VSL and the clock signal VCK become a signal of a selection level, the cells c included in each selector block output a scanning signal “Vg#on” of a selection level to the scan lines connected to the cells. The scanning signal “Vg#on” of a selection level can therefore be sequentially applied to all scan lines during one frame period by, as mentioned above, applying the block select signal VSL and the clock signal VCK.

Counter-electrode signals are each associated with a specific selector block BLK, and each is an inversion signal that alternates between a counter-electrode signal “Vcom#hi” of positive polarity and a counter-electrode signal “Vcom#low” of negative polarity. For example, counter-electrode signals associated with the selector block BLK1 are VCOMA1 and VCOMB1, and counter-electrode signals associated with the selector block BLKx are VCOMAx and VCOMBx. It is desirable that before a signal of a selection level is applied to the block selector signal of an associated selector block, each counter-electrode signal should have its polarity inverted within four horizontal periods. Also, counter-electrode signals VCOMA and VCOMB are of opposite polarities at least in a period during which a selection level is applied to the scan lines.

FIG. 6 shows driving voltage waveforms only of the pixels connected to a signal line D1, among all pixels of the first horizontal line and second horizontal line driven by the selector block BLK1. The symbols VCOM1 and VCOM2 in the figure denote potentials of the counter-electrode lines of the first horizontal line and second horizontal line, respectively. Also, a voltage of a pixel electrode of the pixels connected to a signal line D1 on a first horizontal line is taken as VS#1, and a voltage of a pixel electrode of the pixels connected to a signal line D1 on a second horizontal line is taken as VS#2.

First, when a block select signal VSL1 and a clock signal VCK1 both reach a selection level on the first horizontal line, the scan driver 101 outputs the selection signal “Vg#on” to a scan line G1. At the same time, the “Dr#SW” connected to COM1 of the counter-electrode driver 401 turns on in accordance with the selection level of the clock signal VCK1 and counter-electrode signal VCOMA1 is applied to COM1.

Since VCOMA1 is “Vcom#hi” in the single frame period shown in the first half of FIG. 6, the signal driver 2 applies a signal voltage of positive polarity to the signal line D1. The pixels connected to the signal line D1 on the first horizontal line, therefore, cause an appropriate counter-electrode voltage to converge on “Vcom#hi” and cause pixel electrode voltage VS#1 to converge on signal voltage VD1 of positive polarity.

At this time, the clock signal VCK1 takes a “Low” level, thus turns off the SW of the pixel and an associated internal “Dr#SW” of the counter-electrode driver, and causes the pixels on the first horizontal line to hold a signal voltage of positive polarity.

Next, the block select signal VSL1 and a clock signal VCK2 both reach a selection level and a selection signal is applied to a scan line G2. Also, since the clock signal VCK2 is of a selection level, “Dr#SW” connected to COM2 of the counter-electrode driver 401 turns off to apply counter-electrode signal VCOMB1 to COM2.

For example, since VCOMB1 is “Vcom#low”, the signal driver 2 applies a signal voltage of negative polarity to the signal line D1. The pixels connected to the signal line D1 on the second horizontal line, therefore, cause an appropriate counter-electrode voltage to converge on “Vcom#low” and cause pixel electrode voltage VS#2 to converge on signal voltage VD1 of negative polarity.

At this time, when clock signal VCK2 takes a “Low” level, the pixels on the second horizontal line hold a signal voltage of negative polarity. After this, the block select signal VSL1 maintains a “Low” level until a write operation has been conducted in the next frame. Under the “Low” level state of VSL1, VCK1 reaches a selection level at a rate of once every four horizontal periods. At this time, “Dr#SW” connected to COM1 of the counter-electrode driver 401 turns on to apply the voltage signal of VCOMA1 to COM1 even during the hold period.

Meanwhile, VCK2 also reaches a selection level at the rate of once every four horizontal periods, and since “Dr#SW” connected to COM2 of the counter-electrode driver 401 turns on at this time, the voltage signal of VCOMB1 is applied to COM2, even during the hold period.

During these hold periods, neither VCOMA nor VCOMB changes in voltage polarity. The polarities of counter-electrode voltages, therefore, do not change until the next signal voltage has been rewritten.

In the frame period shown in the second half of FIG. 6, although the signal voltages on the first and second horizontal lines are likewise rewritten by VG1 and VG2, the counter-electrode signals VCOMA1 and VCOMB1 that the counter-electrode signal generator 501 outputs at that time are inverted in terms of polarity. Therefore, the polarity of the signal voltage which the signal driver 2 outputs to the signal line D1 is also inverted and signal voltages of polarities opposite to those shown in the frame period shown in the first half are held by each pixel.

Repeating the above driving for each frame makes it possible to implement counter-electrode inversion driving that inverts the polarities of signal voltages for each horizontal line.

Use of the liquid-crystal display device and its driving method in the second embodiment of the present invention provides the invention with the features and characteristics listed in items (1) to (7) below.

(1) The polarities of the counter-electrode voltages are not inverted during a time interval from completion of signal voltage held by the pixels of each horizontal line, to a start of each horizontal line rewriting operation in the following frame period. This makes it possible to Implement high-quality display during which nonuniform display, called “graded luminance” or “vertical smear”, is suppressed.

(2) Even during the hold period that follows writing, counter-electrode signals can be applied at fixed periods to the counter-electrode lines on each horizontal line.

(3) A high-quality display device that does not easily cause flickering, even at low frame frequencies, can be obtained since polarity inversion of the counter-electrode voltages applied to the counter electrodes of each horizontal line occurs in distributed form for each line within the frame period.

(4) The polarities of the counter-electrode voltages are not inverted during the time interval from completion of signal voltage held by the pixels of each horizontal line, to the start of each horizontal line rewriting operation in the following frame period. Thus, it becomes possible to reduce voltage amplitude of the scanning signal, compared with that achievable in the conventional technology, and hence to reduce elements in withstand voltage. Also, deterioration of the elements can be lessened by reducing the voltage amplitude of the scanning signal, and thus a high-quality display device can be obtained.

(5) on each horizontal line, the counter-electrode lines are in a floating state during a non-selection period. Therefore, the loads applied to each signal line having a parasitic capacitance between counter-electrode lines are reduced and a convergence time up to an arrival of the signal voltage applied to the signal line, at a target potential, is improved as a result. A display device suitable for high-speed operation can thus be obtained.

(6) Because of its small circuit scale, the counter-electrode driver 401 can be formed on the same substrate as that on which the switching element SW of each pixel 3 is formed.

(7) Since the counter-electrode driver 401 can be controlled using the scanning signal of the scan driver 101, there is no need to provide an independent control signal for the counter-electrode driver 401.

In the configuration diagram of FIG. 4, one set of counter-electrode signal lines consisting of two lines, COMA and COMB, are shown as signal output lines of the counter-electrode signal generator 501. As with above-described inversion driving, however, counter-electrode inversion driving that inverts the polarities of signal voltages for each horizontal period can be realized. That is, this is possible by: using one counter-electrode signal line, instead of two lines, for each selector block, to connect a drain terminal of the “Dr#SW” within the counter-electrode driver 401 to an appropriate counter-electrode signal line, and inverting, for each horizontal period, the polarity of the signal applied to the counter-electrode signal line.

Also, although in the above description, the polarity inversion period of signal voltages during counter-electrode inversion driving is set to be equal to one horizontal period, this polarity inversion period may be arbitrarily set. This can be realized by setting the polarities and alternating-current periods of VCOMA and VCOMB as appropriate.

Additionally, for improved writing into the pixel electrode and the counter electrode, circuit operation can be combined with double-gate driving in which signal voltages of the same polarity are temporarily written.

Furthermore, in the configuration diagram of FIG. 4, use of amorphous Si or polysilicon makes it possible to form the pixel matrix and the counter-electrode driver or the pixel matrix, the counter-electrode driver, and the scan driver, on one substrate and arrange other circuits on peripheral sections of the substrate.

### Third Embodiment

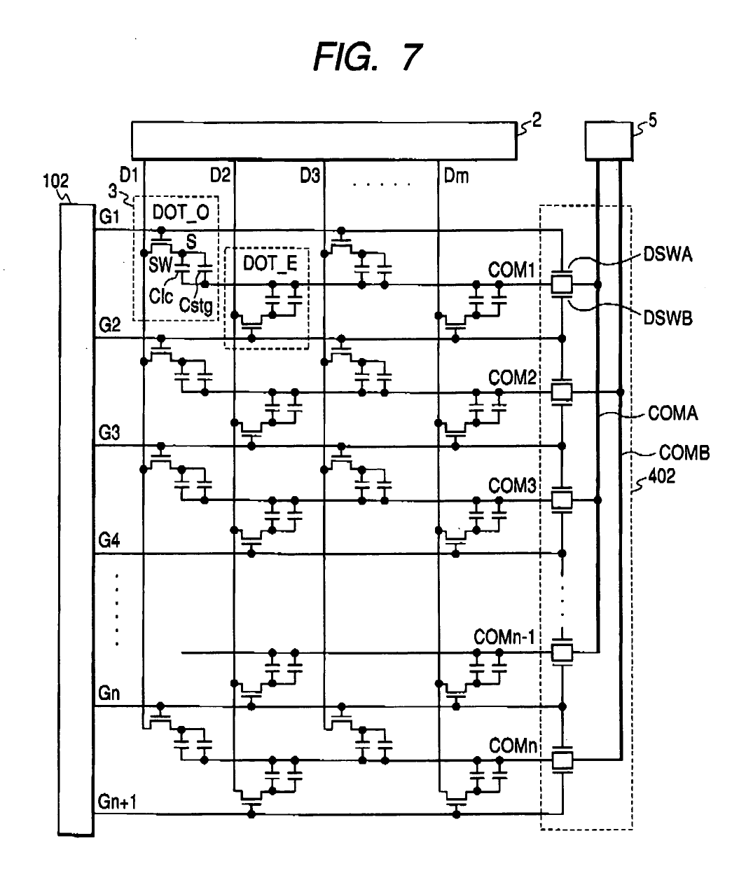

Next, a third embodiment of a display device and its driving method according to the present invention is described with reference to FIGS. 7 to 9.

FIG. 7 is a schematic diagram showing a configuration of the liquid-crystal display device operating in the third embodiment of the present invention. The configuration of the liquid-crystal display device in the third embodiment is described below. A signal driver 2, a counter-electrode signal generator 5, and a pixel matrix formed up of pixels 3 are not described since these elements are of the same configurations as those employed in the first embodiment of the present invention.

The liquid-crystal display device shown in FIG. 7 is described assuming that the number of dots in a horizontal direction is “m” and that the number of lines in a vertical direction is “n”. An “n+1” number of scan lines from which the scanning signal output from a scan driver 102 is to be applied to each pixel 3 are arranged as G1, G2, G3, G4, . . . Gn+1, Gn, in the liquid-crystal display device. Also, in order to apply to each pixel the signal voltage that the signal driver 2 outputs, an “m” number of signal lines are arranged as D1, D2, . . . Dm, in the direction where the signal lines intersect the scan lines.

In order to apply to counter electrodes of each pixel the counter-electrode signal that a counter-electrode driver 402 outputs, an “n” number of counter-electrode lines are arranged as COM1, COM2, COM3, COM4, . . . , COMn−1, COMn, in the same direction as that of the scan lines. A pixel 3 including a switching element SW is disposed in the vicinity of positions at which each scan line and each signal line intersect each other. In the liquid-crystal display device, therefore, an “m” number of pixels and an “n” number of pixels are arranged in a matrix format in horizontal and vertical directions, respectively.

The pixels for one horizontal line that are connected to one counter-electrode line are driven by two scan lines adjacent to that counter-electrode line. Scan lines adjacent to COM1 on a first horizontal line, for example, are G1 and G2. In this case, of all pixels connected to COM1 on the first horizontal line, for example, only DOT#0, a pixel connected to an odd-numbered signal line, has a gate terminal of its switching element SW connected to the scan line G1, and DOT#E, a pixel connected to an even-numbered signal line, has a gate terminal of its switching element SW connected to the scan line G2. Although these pixels are alternately connected one by one to G1 and G2, this period may be arbitrarily set.

Since a second horizontal line onward is also connected similarly, the number of scan lines G needs to be one greater than the number of pixels formed in the vertical direction. A drain terminal of the switching element SW of the pixel 3 is connected to an associated signal line D, and the counter electrode of the pixel 3 is connected to an associated counter-electrode line COM.

The counter-electrode driver 402 includes an “n” number of switching circuits each formed up of two elements, DSWA and DSWB, as a set. The elements used as DSWA and DSWB are both a three-terminal element such as a TFT, which is formed of amorphous Si, polysilicon, single-crystal Si, or the like. Source terminals of DSWA and DSWB are both connected to an associated counter-electrode line COM. Drain terminals of DSWA and DSWB are connected, for example, alternately for each horizontal line, to a first counter-electrode line COMA and a second counter-electrode line COMB, respectively.

For the liquid-crystal display device of FIG. 7, odd-numbered lines are connected to COMA, and even-numbered lines, to COMB. Gate terminals of DSWA and DSWB are connected to the two scan lines that control the pixels sharing the counter-electrode lines connected to the source terminals of DSWA and DSWB.

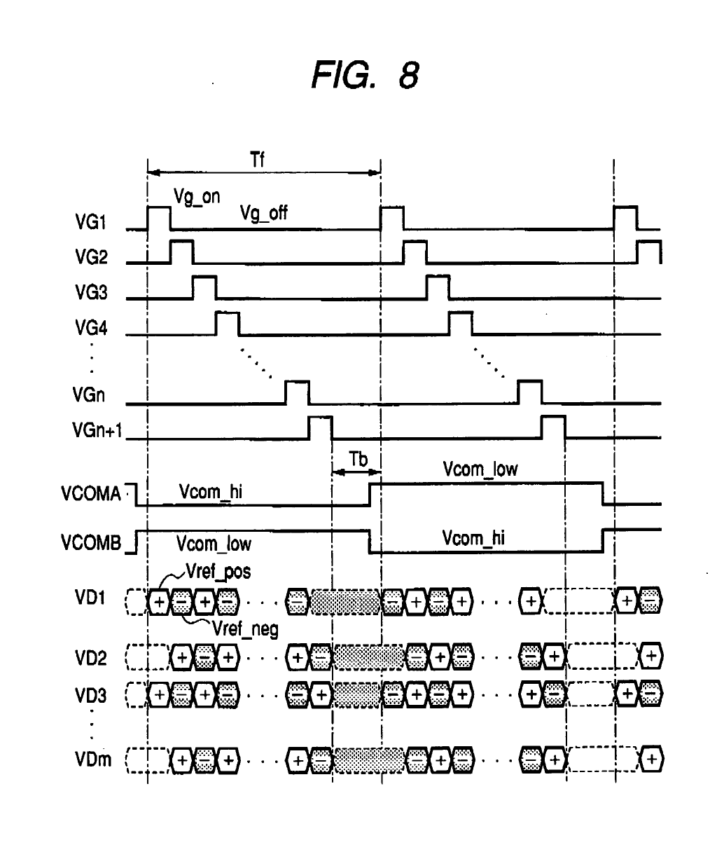

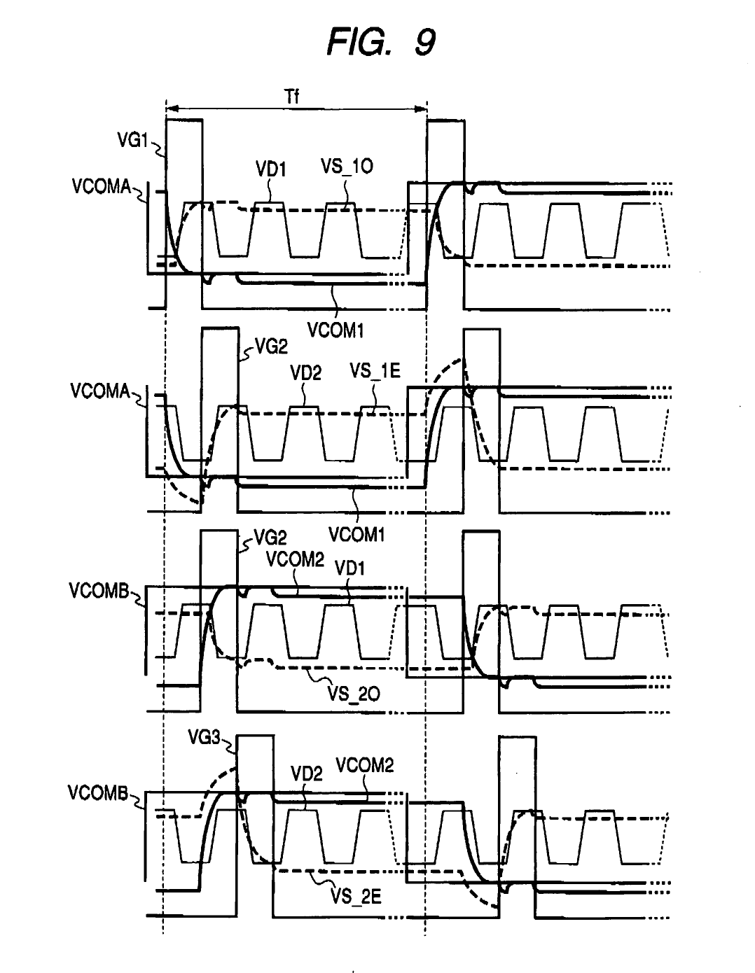

Next, a driving method for the liquid-crystal display device of the third embodiment is described below with reference to FIGS. 8 and 9. The following description assumes that the TFTs used as the switching element SW and the switching elements DSWA and DSWB are, for example, n-type TFTs. The following description also assumes counter-electrode inversion driving by which polarity of the signal voltage output by the signal driver 2 is inverted in increments of, for instance, one horizontal period.

FIG. 8 is a chart that shows timing of the signals output by the scan driver 102, the signal driver 2, and the counter-electrode signal generator 5. Symbols VG1, VG2, VG3, VG4, . . . VGn, VGn+1, denote the scanning signals applied to the scan lines G1, G2, G3, G4, . . . Gn, Gn+1, respectively.

The scan driver 1 applies “Vg#on” to each scan line at least once during one frame period Tf. A state in which “Vg#on” is sequentially applied to each scan line from G1 to Gn+1 is shown in the figure. The scan driver 102 repeats this operation sequence for each frame.

Symbols VCOMA and VCOMB denote the counter-electrode signals that the counter-electrode signal generator 5 generates and then outputs to COMA and COMB, respectively. VCOMA and VCOMB are the inversion signals for “Vcom#hi”, a counter-electrode voltage of positive polarity, and “Vcom#low”, a counter-electrode voltage of a negative polarity. The VCOMA and VCOMB signals have the respective polarities inverted within one-frame blanking period Tb. Alternating-current frequencies of VCOMA and VCOMB, therefore, become ½ of a frame frequency. At least during a period of signal voltage writing into pixels, VCOMA and VCOMB function as counter-electrode voltages of opposite polarities.

Symbols VD1, VD2, . . . VDm signify the signal voltages that the signal driver 2 applies to the signal lines D1, D2, etc. up to Dm. Also, “Vref#pos” denotes a signal voltage of positive polarity, and “Vref#neg” denotes a signal voltage of negative polarity. In line with a period during which the scan driver 102 selects pixels, the signal driver 2 outputs a signal voltage appropriate for display signals associated with each pixel selected. The polarity of the signal voltage at that time depends on the polarity of the counter-electrode signal applied to the counter electrode of the pixel. A signal voltage of positive polarity, “Vref#pos”, is output to the pixel to which “Vcom#hi” is applied, and a signal voltage of negative polarity, “Vref#neg”, is output to the pixel to which “Vcom#low” is applied.

During the frame period shown in the first half of FIG. 8, odd-numbered counter-electrode lines are connected to COMA via DSWA and DSWB. Since the signal of COMA is “Vcom#hi”, during a selection period for the pixels connected to the odd-numbered counter-electrode lines, the signal voltage of positive polarity, “Vref#pos”, is output to the signal lines connecting to these pixels.

Even-numbered counter-electrode lines are connected to COMB via DSWA and DSWB. Since the signal of COMB is “Vcom#low”, during a selection period for the pixels connected to the even-numbered counter-electrode lines, the signal voltage of negative polarity, “Vref#neg”, is output to the signal lines connecting to these pixels. In the frame period that follows, signal polarities of VCOMA and VCOMB are inverted, so that the polarities of the signal voltages output to each pixel are also inverted.

FIG. 9 is a diagram that shows the voltage waveforms developed at pixels when the signals shown in FIG. 8 are applied to the pixels. Of all pixels connected to the signal lines D1 and D2, for example, only the pixels connected to the counter-electrode lines COM1 and COM2 have the respective voltage waveforms shown in FIG. 9.

In FIG. 9, symbol VS#1O denotes a pixel electrode voltage developed at the pixel where the signal line D1 and the counter-electrode line COM1 are connected to each other, and VS#1E denotes a pixel electrode voltage developed at the pixel where the signal line D2 and the counter-electrode line COM1 are connected to each other. Also, VS#2O denotes a pixel electrode voltage developed at the pixel where the signal line D1 and the counter-electrode line COM2 are connected, and VS#2E denotes a pixel electrode voltage developed at the pixel where the signal line D2 and the counter-electrode line COM2 are connected to each other. In addition, VCOM1 denotes a voltage signal of the counter-electrode line COM1 on a first horizontal line, and VCOM2 denotes a voltage signal of the counter-electrode line COM2 on a second horizontal line.

First, in one frame period shown in the first half of FIG. 9, when the pixel connected to an odd-numbered signal line on the first horizontal line is selected by the scanning signal VG1, VCOMA is applied to the counter-electrode COM1 via the appropriate internal DSWA of the counter-electrode driver 402. The voltage VCOM1 of the counter electrode COM1, therefore, converges on “Vcom#hi”.

A positive-polarity signal voltage VD1 appropriate for the display signal of the pixel is applied from the signal line D1 to the pixel electrode via the switching element SW, and VS#1O converges on VD1. After the VG1-based selection period, since the switching element SW and the DSWA connected to COM1 are both turned off, although the pixel electrode and the counter electrode COM1 enter a floating state, the signal voltage of positive polarity that was applied during the selection period is held by a liquid crystal capacitor “Clc” and a hold capacitor “Cstg”.

Next, application of a selection signal to G2 via the scanning signal VG2 selects the pixel connected to the even-numbered signal line on the first horizontal line, and the pixel connected to the appropriate odd-numbered signal line on the first horizontal line.

First, for the pixel connected to the counter-electrode line COM1 on the first horizontal line and to the even-numbered signal line D2, VCOMA is applied to the counter-electrode COM1 via the appropriate internal DSWB of the counter-electrode driver 402 and thus the appropriate pixel electrode voltage converges on “Vcom#hi”. A positive-polarity signal voltage VD2 appropriate for the display signal of the pixel is applied from the signal line D2 to the pixel electrode via the switching element SW, and VS#1E converges on signal voltage VD2.

For the pixel connected to the counter-electrode line COM2 on the second horizontal line and to the odd-numbered signal line D1, VCOMB is applied to COM2 via the appropriate internal DSWA of the counter-electrode driver 402 and thus the appropriate pixel electrode voltage converges on “Vcom#low”. A negative-polarity signal voltage VD1 appropriate for the display signal of the pixel is applied from the signal line D1 to the pixel electrode via the switching element SW, and VS#2O converges on signal voltage VD1.

After the VG2-based selection period, since the DSWB connected to the switching element SW of the pixel and to COM1 and the DSWA connected to COM2 are both turned off, although the pixel electrode and the counter electrode COM1 enter a floating state, the signal voltage of positive or negative polarity that was applied during the selection period is held by the liquid crystal capacitor “Clc” and the hold capacitor “Cstg”.

Next, application of a selection signal to G3 via the scanning signal VG3 selects the pixel connected to the counter-electrode COM2 and even-numbered signal line D2 on the second horizontal line, and the pixel connected to the counter-electrode COM3 and odd-numbered signal line D1 on a third horizontal line.

First, for the pixel connected to COM2 and D2, VCOMB is applied to the counter-electrode COM2 via the appropriate internal DSWB of the counter-electrode driver 402 and thus VCOM2 converges on “Vcom#low”. A negative-polarity signal voltage VD2 appropriate for the display signal of the pixel is applied from the signal line D2 to the pixel electrode via the switching element SW, and VS#2E converges on signal voltage VD2.

Meanwhile, although a waveform is not shown, for the pixel connected to COM3 and D1, VCOMA is applied to the counter electrode COM3 via the appropriate internal DSWA of the counter-electrode driver 402 and thus VCOM3 converges on “Vcom#hi”. A positive-polarity signal voltage VD1 appropriate for the display signal of the pixel is applied from the signal line D1 to the pixel electrode via the switching element SW, and the appropriate pixel electrode voltage converges.

After the VG3-based selection period, since the DSWB connected to the switching element SW of the pixel and to COM2 and the DSWA connected to COM3 are both turned off, although the pixel electrode and the counter electrode enter a floating state, the signal voltage of positive or negative polarity that was applied during the selection period is held by the liquid crystal capacitor “Clc” and the hold capacitor “Cstg”. During a hold period of the signal voltage, since the counter electrode and the pixel electrode are in a floating state, the polarity of the signal on the counter-electrode line is not inverted, even when the polarities of VCOMA and VCOMB are inverted.

The signal voltage that is associated with a one-frame display signal and has been polarity-inverted for each horizontal line can be held in the pixels of all horizontal lines by sequential repetition of the operation described above. During the frame period shown in the second half of the figure, the polarity of the counter-electrode voltage is inverted on each horizontal line, the signal voltage output from the signal driver 2 to each pixel also assumes opposite polarity, and similar driving is conducted. Thus, a signal voltage that is associated with a one-frame display signal and has polarity opposite to that of the signal voltage in the immediately preceding frame can be held in the pixels of all horizontal lines. Repeating above driving for each frame makes it possible to implement counter-electrode inversion driving that inverts the polarities of signal voltages for each horizontal line.

Use of the liquid-crystal display device and its driving method in the third embodiment of the present invention provides the invention with the features and characteristics listed in items (1) to (7) below.

(1) The polarities of the counter-electrode voltages are not inverted during a time interval from completion of signal voltage held by the pixels of each horizontal line, to a start of each horizontal line rewriting operation in the following frame period. This makes it possible to implement high-quality display during which nonuniform display, called “graded luminance” or “vertical smear”, is suppressed.

(2) A high-quality display device that does not easily cause flickering, even at low frame frequencies, can be obtained since polarity inversion of the counter-electrode voltages applied to the counter electrodes of each horizontal line occurs in distributed form for each line within the frame period.

(3) The polarities of the counter-electrode voltages are not inverted during the time interval from completion of signal voltage hold by the pixels of each horizontal line, to the start of each horizontal line rewriting operation in the following frame period. Thus, it becomes possible to reduce voltage amplitude of the scanning signal, compared with that achievable in the conventional technology, and hence to reduce elements in withstand voltage. Also, deterioration of the elements can be lessened by reducing the voltage amplitude of the scanning signal, and thus, a high-quality display device can be obtained.

(4) On each horizontal line, the counter-electrode lines are in a floating state during a non-selection period. Therefore, the loads applied to each signal line having a parasitic capacitance between counter-electrode lines are reduced and a convergence time up to an arrival of the signal voltage applied to the signal line, at a target potential, is improved as a result. A display device suitable for high-speed operation can thus be obtained.

(5) Since the pixels selected via one scan line are connected in a distributed condition to two adjacent counter-electrode lines, this reduces loads thereof, compared with the loads applied in the conventional technology. Consequently, a convergence time of counter-electrode voltages is correspondingly improved and a display device suitable for high-speed operation can be obtained.

(6) Because of its small circuit scale, the counter-electrode driver 402 can be formed on the same substrate as that on which the switching element SW of each pixel is formed.

(7) Since the counter-electrode driver 402 can be controlled using the scanning signal of the scan driver 102, there is no need to provide an independent control signal for the counter-electrode driver 402.

Although in the above description, the polarity inversion period of signal voltages during counter-electrode inversion driving is set to be equal to one horizontal period, this polarity inversion period may be arbitrarily set. This can be realized by setting the polarities and alternating-current periods of VCOMA and VCOMB as appropriate.

Also, for improved convergence on the target voltages on the pixel electrode and the counter electrode, circuit operation can be combined with double-gate driving.

Additionally, in the configuration diagram of FIG. 7, use of amorphous Si or polysilicon makes it possible to form the pixel matrix and the counter-electrode driver or the pixel matrix, the counter-electrode driver, and the scan driver, on one substrate and arrange other circuits on peripheral sections of the substrate.

Furthermore, the advantageous effects of the above-described first to third embodiments according to the present invention can likewise be obtained by combining the scan driver of the selector scheme, described in the second embodiment, and the pixel composition and counter-electrode driver described in the third embodiment.

1. A display device comprising:
a plurality of scan lines;
a plurality of signal lines intersecting said plurality of scan lines;
a plurality of counter-electrode lines each extending along a corresponding one of said plurality of scan lines;
a plurality of pixels each coupled to a corresponding one of said plurality of scan lines, a corresponding one of said plurality of signal line and a corresponding one said plurality of counter-electrode lines;
a first driver that applies a scanning signal to each of said plurality of scan lines;
a second driver that applies a signal voltage to each of said plurality of signal lines;
a third driver that applies a counter-electrode voltage to each of said plurality of counter-electrode lines; and
a generator that supplies a counter-electrode signal to said third driver;
wherein, when the scanning signal is applied to one of said plurality of scan lines, said third driver applies the counter-electrode voltage to one of said plurality of counter-electrode lines associated with said one of said plurality of scan lines.

2. The display device according to claim 1, wherein said third driver has a plurality of switching circuits each associated with a corresponding one of said plurality of counter electrode lines, and each of said plurality of switching circuits applies the counter-electrode voltage to a corresponding one of said plurality of counter-electrode lines when one of said plurality of scan lines associated with said corresponding one of said plurality of counter-electrode lines is supplied with the scanning signal.

3. The display device according to claim 2, wherein said plurality of counter-electrode lines are divided into two groups, the counter-electrode signal includes two different signals, and said plurality of switching circuits are configured such that one of said two different signals are supplied to one of the two groups of the counter-electrode lines, and another of said two different signals are supplied to another of the two groups of the counter-electrode lines.

4. A display device comprising:
a plurality of scan lines;
a plurality of signal lines intersecting said plurality of scan lines;
a plurality of counter-electrode lines each extending along a corresponding one of said plurality of scan lines;
a plurality of pixels each coupled to a corresponding one of said plurality of scan lines and a corresponding one of said plurality of signal lines;
a first driver which applies a scanning signal to each of said plural scan lines;
a second driver which applies a signal voltage to each of said plurality of signal lines;
a generator which generates a counter-electrode signal for said plurality of counter-electrode lines; and
a third driver which receives the counter-electrode signal sent from said generator;
wherein
said first driver is divided into a plurality of blocks;
said plurality of blocks are controlled based upon a selection signal for selecting one from among said plurality of blocks and a clock signal for sequentially scanning said plurality of scan lines within each of said plurality of blocks;
each of said plurality of block applies a selection voltage to a corresponding one of said plurality of scan lines when the selection signal and the clock signal change to selection levels; and
said third driver applies a counter-electrode voltage to a corresponding one of said plurality of counter-electrode lines when the clock signal changes to the selection level.

5. The display device according to claim 4, wherein:
said third driver has a plurality of switching circuits each associated with one of said plurality of counter-electrode lines; and each of said switching circuits applies the counter-electrode voltage to a corresponding one of said plurality of counter-electrode lines associated with one of said plurality of scan lines supplied with the scanning signal.

6. The display device according to claim 5, wherein said plurality of counter-electrode lines are divided into two groups, the counter-electrode signal includes two different signals, and said plurality of switching circuits are configured such that one of said two different signals are supplied to one of the two groups of the counter-electrode lines, and another of said two different signals are supplied to another of the two groups of the counter-electrode lines.

7. A display device comprising:
a plurality of scan lines;
a plurality of signal lines intersecting said plurality of scan lines;
a plurality of counter-electrode lines each extending along a corresponding one of said plurality of scan lines;
a plurality of pixels each coupled to a corresponding one of said plurality of scan lines, a corresponding one of said plurality of signal lines, and a corresponding one of said plurality of counter-electrode lines,
ones of said plurality of pixels arranged in one row being coupled to one of said plurality of counter-electrode lines, said ones of said plurality of pixels arranged in said one row being divided into two groups, pixels in one of the two groups being coupled to one of two adjacent ones of said scan lines, and pixels in another of the two groups being coupled to another of the two adjacent ones of said scan lines,
a first driver that applies a scanning signal to each of said plurality of scan lines;
a second driver that applies a signal voltage to each of said plurality of signal lines;
a generator that generates two different counter-electrode signals; and
a third driver that has a plurality of switching circuits each associated with one of said plurality of counter-electrode lines;
wherein
said plurality of counter-electrode lines are divided into two groups;
one of said two groups of said counter-electrode lines receives one of the two different counter-electrode signals via at least two switching circuits;
another of said two groups of said counter-electrode lines receives another of the two different counter-electrode signals via at least two switching circuits; and
said at least two switching circuits are each coupled to two of said plurality of scan lines that drive a row of pixels among said plurality of pixels coupled to one of said counter-electrode lines coupled to said at least two switching circuits, and
said at least two switching circuits apply a counter-electrode voltage to a corresponding one of said counter-electrode lines associated with one of said plurality of scan lines being supplied with the scanning signal.

8. The display device according to claim 7, wherein said first driver and said third driver are formed on a same substrate as said plurality of pixels are formed on.

9. A driving method for a display device, said display device comprising:
a plurality of scan lines;
a plurality of signal lines intersecting said plurality of scan lines;
a plurality of counter-electrode lines each extending along a corresponding one of said plurality of scan lines;
a plurality of pixels each coupled to a corresponding one of said plurality of scan lines, a corresponding one of said plurality of signal line and a corresponding one said plurality of counter-electrode lines;
a first driver that applies a scanning signal to each of said plurality of scan lines;
a second driver that applies a signal voltage to each of said plurality of signal lines;
a third driver that applies a counter-electrode voltage to each of said plurality of counter-electrode lines; and
a generator that supplies a counter-electrode signal to said third driver;
said driving method comprising:
applying two different counter-electrode voltages from the third driver to the counter-electrode lines;
supplying two different counter-electrode signals from the generator to the third driver; and
applying the counter-electrode voltage to one of said plurality of counter-electrode lines associated with one of said plurality of scan lines to which the scanning signal is applied.

10. A driving method for a display device,
said display device comprising:
a plurality of scan lines;
a plurality of signal lines intersecting said plurality of scan lines;
a plurality of counter-electrode lines each extending along a corresponding one of said plurality of scan lines;
a plurality of pixels each coupled to a corresponding one of said plurality of scan lines and a corresponding one of said plurality of signal lines;
a first driver which applies a scanning signal to each of said plural scan lines, said first driver being divided into a plurality of blocks;
a second driver which applies a signal voltage to each of said plurality of signal lines;
a generator which generates a counter-electrode signal for said plurality of counter-electrode lines; and
a third driver which receives the counter-electrode signal sent from said generator;
said driving method comprising:
controlling said plurality of blocks based upon a selection signal for selecting one from among said plurality of blocks and a clock signal for sequentially scanning said plurality of scan lines within each of said plurality of blocks;
applying a selection voltage to a corresponding one of said plurality of scan lines when the selection signal and the clock signal change to selection levels;
supplying the counter-electrode signal to said third driver from said generator; and
applying a counter-electrode voltage to a corresponding one of said plurality of counter-electrode lines when the clock signal changes to the selection level.

11. The driving method according to claim 10, wherein the counter-electrode signal for each of said plurality of blocks is alternated between a positive-polarity voltage and a negative-polarity voltage at intervals of a frame period, and inversion of a polarity of the counter-electrode signal is performed before rewriting of the signal voltages applied to corresponding ones of said plurality of signal lines within a corresponding one of said plurality of blocks.

12. A driving method for a display device,
said display device comprising:
a plurality of scan lines;
a plurality of signal lines intersecting said plurality of scan lines;
a plurality of counter-electrode lines each extending along a corresponding one of said plurality of scan lines, said plurality of counter-electrode lines being divided into two groups;
a plurality of pixels each coupled to a corresponding one of said plurality of scan lines, a corresponding one of said plurality of signal lines, and a corresponding one of said plurality of counter-electrode lines,
ones of said plurality of pixels arranged in one row being coupled to one of said plurality of counter-electrode lines, said ones of said plurality of pixels arranged in said one row being divided into two groups, pixels in one of the two groups being coupled to one of two adjacent ones of said scan lines, and pixels in another of the two groups being coupled to another of the two adjacent ones of said scan lines,
a first driver that applies a scanning signal to each of said plurality of scan lines, said first driver being divided in a plurality of blocks;
a second driver that applies a signal voltage to each of said plurality of signal lines;
a generator that generates two different counter-electrode signals; and
a third driver that has a plurality of switching circuits each associated with one of said plurality of counter-electrode lines
said driving method comprising:
applying one of the two different counter-electrode voltages to one of said two groups of said counter-electrode lines;
applying another of the two different counter-electrode signals to another of said two groups of said counter-electrode lines; and
applying a counter-electrode voltage to a corresponding one of said plurality of counter-electrode lines associated with one of said plurality of scan lines being supplied with the scanning signal.

13. The driving method according to claim 11, wherein the two different counter-electrode signals are a positive-polarity voltage and a negative-polarity voltage alternating with each other at intervals of a frame period, and an alternation between the positive-polarity and negative-polarity voltages are performed within a blanking period during which rewriting of the signal voltages applied to corresponding ones of said plurality of signal lines is not performed.
